(19) United States
(12) Patent Application Publication
(10) Pub. No.: US 2025/0095893 A1
(43) Pub. Date: Mar. 20, 2025

(54) COIL COMPONENT

(71) Applicant: TAIYO YUDEN CO., LTD., Tokyo (JP)

(72) Inventors: Koichiro Wada, Tokyo (JP); Hideki Ogawa, Tokyo (JP); Shintaro Takahashi, Tokyo (JP); Toshiyuki Yagasaki, Tokyo (JP)

(21) Appl. No.: 18/883,249

(22) Filed: Sep. 12, 2024

(30) Foreign Application Priority Data
Sep. 15, 2023 (JP) 2023-150447

(51) Int. Cl. H01F 3/08; H01F 5/04

(52) U.S. Cl. CPC H01F 3/08; H01F 5/04

(57) ABSTRACT

Disclosed herein is a coil component including a base including a plurality of magnetic metal particles, and a coil conductor wound around a coil axis inside the base, in which the base includes a first magnetic portion provided outside the coil conductor in radial directions centered on the coil axis, and a second magnetic portion provided inside the first magnetic portion in the radial directions, and a first filling rate is in a range of 0.9 to 1.1 times a second filling rate, both inclusive, the first filling rate representing a filling rate of the magnetic metal particles in the first magnetic portion, and the second filling rate representing a filling rate of the magnetic metal particles in the second magnetic portion.

### CROSS REFERENCE TO RELATED APPLICATIONS

This application claims priority benefit of Japanese Patent Application No. JP 2023-150447 filed in the Japan Patent Office on Sep. 15, 2023. Each of the above-referenced applications is hereby incorporated herein by reference in its entirety.

### BACKGROUND

The disclosure of the present specification mainly relates to a coil component and a method for manufacturing the coil component.

Coil components are installed in various electronic devices. The coil components are used, for example, to eliminate noise in power supply lines and signal lines of circuits. A common coil component includes a base made of a magnetic material, and a coil conductor provided on the base.

A base of a coil component described in Japanese Patent Laid-open No. 2021-163859 (hereinafter, referred to as Patent Document 1) includes a magnetic core having a columnar portion around which a coil conductor is wound, and an exterior member covering the coil conductor. Such a coil component is made by winding the coil conductor around the columnar portion of the magnetic core, and disposing the exterior member so as to cover the coil conductor. Each of the magnetic core and the exterior member is formed by subjecting a mixed resin composition containing resin and magnetic powder to compression molding.

### SUMMARY

There has been a demand for reduction in size of coil components. As described in Patent Document 1, reducing the size of a coil component by reducing the thickness of an exterior member has been under study.

However, a coil component having an exterior member with a reduced thickness has a problem in that, when the exterior member is made from a mixed resin composition, magnetic metal particles included in the mixed resin composition are not easily filled into the exterior member with a reduced thickness, resulting in deterioration in magnetic characteristics of the coil component.

It is desirable to overcome or alleviate at least a part of the above-described problem. It is more desirable to prevent or minimize deterioration in magnetic characteristics of a coil component having a reduced size.

It is desirable to become more apparent by reference to the whole of the present specification. The disclosure in the present specification may overcome a problem that will be grasped from the disclosure of the present specification instead of the abovementioned problem or in addition to the abovementioned problem.

A coil component according to an embodiment of the present disclosure includes a base including a plurality of magnetic metal particles, and a coil conductor wound around a coil axis inside the base. The base includes a first magnetic portion provided outside the coil conductor in radial directions centered on the coil axis, and a second magnetic portion provided inside the first magnetic portion in the radial directions. A first filling rate is in a range of 0.9 to 1.1 times a second filling rate, both inclusive, the first filling rate representing a filling rate of the magnetic metal particles in the first magnetic portion, and the second filling rate representing a filling rate of the magnetic metal particles in the second magnetic portion.

An embodiment of the disclosure in the present specification is able to prevent or minimize deterioration in magnetic characteristics of a coil component having a reduced size.

### BRIEF DESCRIPTION OF THE DRAWINGS

FIG. 1 is a schematic perspective view of a coil component according to a first embodiment of the present disclosure;

FIG. 2 is a schematic sectional view of a section of the coil component taken along line I-I in FIG. 1;

FIG. 3 is a sectional view of a first magnetic portion of a base included in the coil component of FIG. 1;

FIG. 4 is an enlarged sectional view of a portion of the section illustrated in FIG. 2;

FIG. 5 is a sectional view of a coil component according to a second embodiment of the present disclosure;

FIG. 6 is a sectional view of a first magnetic portion of a base included in the coil component of FIG. 5;

FIG. 7 is a schematic sectional view of a coil component according to a third embodiment of the present disclosure;

FIG. 8 is a sectional view of a first magnetic portion of a base included in the coil component of FIG. 7;

FIG. 9A is a schematic diagram for explaining a step of preparing a mixed resin composition in a method for manufacturing the coil component;

FIG. 9B is a schematic diagram for explaining a step of molding a first molded body in the method for manufacturing the coil component;

FIG. 9C is a schematic diagram for explaining a step of setting a coil conductor in the method for manufacturing the coil component;

FIG. 9D is a schematic diagram for explaining a step of molding a second molded body in the method for manufacturing the coil component;

FIG. 9E is a schematic diagram for explaining a grinding step for making lead portions of the coil conductor exposed in the method for manufacturing the coil component;

FIG. 9F is a schematic diagram for explaining a polishing step in the method for manufacturing the coil component; and

FIG. 9G is a schematic diagram for explaining a step of forming external electrodes in the method for manufacturing the coil component.

### DETAILED DESCRIPTION OF THE PREFERRED EMBODIMENTS

Hereinafter, various embodiments of the present disclosure will be described with reference to the accompanying drawings as appropriate. Note that constituent elements that appear in a plurality of drawings are denoted by the same reference signs consistently across the plurality of drawings. It is to be noted that, for the sake of convenience in description, each drawing may not necessarily be depicted to an accurate scale. The embodiments of the present disclosure described below are not meant to limit the scope of the disclosure defined by the appended claims. Elements of the embodiments described in the following description may not necessarily be essential to the present disclosure.

### 1. First Embodiment

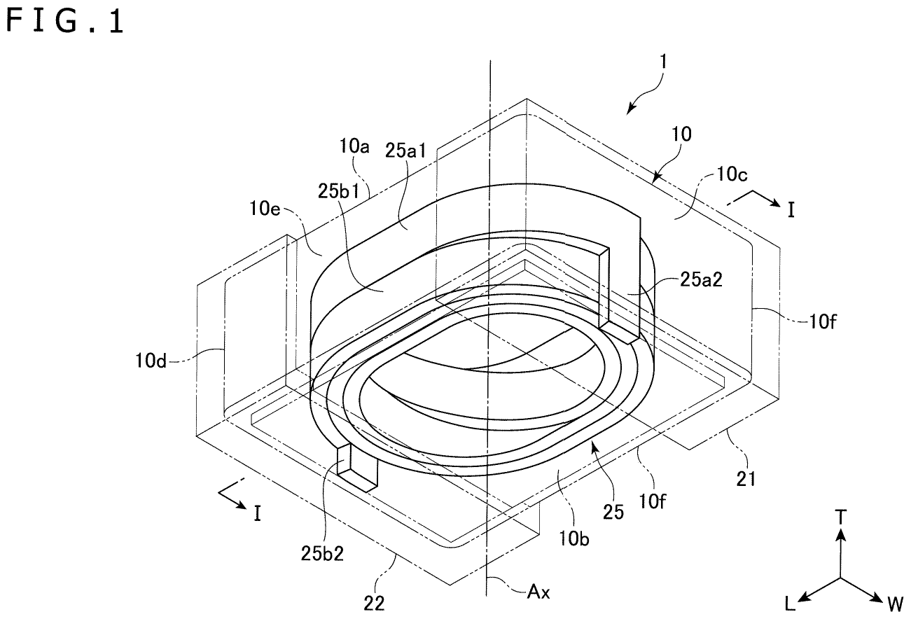

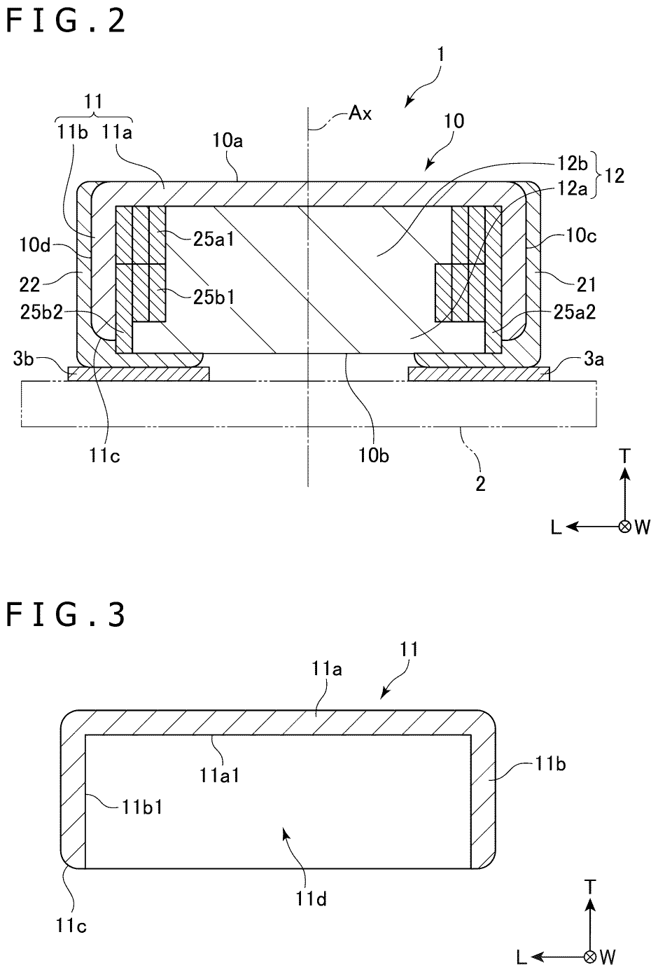

A coil component 1 according to a first embodiment of the present disclosure will be described below with reference to FIGS. 1 and 2. FIG. 1 is a perspective view of the coil component 1 according to the first embodiment of the present disclosure, and FIG. 2 is a vertical sectional view of the coil component 1 mounted on a mount board 2. In FIG. 1, the mount board 2 is not depicted.

In the accompanying drawings, a W-axis, an L-axis, and a T-axis perpendicular to one another are depicted. It is assumed in the present specification that the “length” direction, “width” direction, and “thickness” direction of the coil component 1 correspond to an “L-axis” direction, a “W-axis” direction, and a “T-axis” direction, respectively, unless otherwise interpreted contextually. In the present specification, the orientations and arrangements of constituent elements of the coil component 1 will sometimes be described with reference to the L-axis direction, the W-axis direction, and the T-axis direction.

The coil component 1 may be used as an inductor, a transformer, a filter, a reactor, or any of various other inductance elements. The coil component 1 may be a coupled inductor, a choke coil, or any of various other magnetic coupling-type coil components. Applications of the coil component 1 are not limited to those specified in the present specification.

As illustrated in FIG. 1, the coil component 1 includes a base 10 having an insulating property, a coil conductor 25 provided in the base 10, a first external electrode 21 provided on an external surface of the base 10, and a second external electrode 22 provided on the external surface of the base 10 and at a position apart from the first external electrode 21. In the illustrated embodiment, the coil conductor 25 is provided inside the base 10. In FIG. 1, for the sake of convenience in description, the coil conductor 25 is depicted as if the base 10, the first external electrode 21, and the second external electrode 22 are transparent.

As illustrated in FIG. 2, the coil component 1 may be mounted on the mount board 2. Land portions 3a and 3b are provided on the mount board 2. The first external electrode 21 is joined to the land portion 3a, and the second external electrode 22 is connected to the land portion 3b, whereby the coil component 1 is mounted on the mount board 2. The mount board 2 having the coil component 1 mounted thereon can be installed in various electronic devices. Examples of electronic devices in which the mount board 2 can be installed include a smart phone, a tablet computer, a game console, an electronic part of an automobile, a server, and various other electronic devices.

The base 10 is made of a magnetic material, and is substantially in the shape of a rectangular parallelepiped. In one embodiment of the present disclosure, the base 10 is arranged to have a dimension (longitudinal dimension) in the L-axis direction greater than each of a dimension (width dimension) thereof in the W-axis direction and a dimension (height dimension) thereof in the T-axis direction. The base 10 is arranged to be compact to achieve a reduced size of the coil component 1. For example, the base 10 has a longitudinal dimension in the range of 0.5 to 3.0 mm, a width dimension in the range of 0.5 to 3.0 mm, and a height dimension in the range of 0.3 to 0.5 mm. The dimensions of the base 10 are not limited to the dimensions specifically described in the present specification. The terms “rectangular parallelepiped” and “shape of a rectangular parallelepiped” as used in the present specification do not refer to only a “rectangular parallelepiped” in an exact mathematical sense. The dimensions and shape of the base 10 are not limited to those specified in the present specification.

The base 10 includes a first principal surface 10a, a second principal surface 10b, a first end surface 10c, a second end surface 10d, a first side surface 10e, and a second side surface 10f. These six surfaces define outer surfaces of the base 10. The first principal surface 10a and the second principal surface 10b form surfaces of the base 10 at both ends in the heightwise direction, the first end surface 10c and the second end surface 10d form surfaces of the base 10 at both ends in the longitudinal direction, and the first side surface 10e and the second side surface 10f form surfaces of the base 10 at both ends in the width direction. The first principal surface 10a and the second principal surface 10b are apart from each other by a distance equal to the height dimension of the base 10, the first end surface 10c and the second end surface 10d are apart from each other by a distance equal to the longitudinal dimension of the base 10, and the first side surface 10e and the second side surface 10f are apart from each other by a distance equal to the width dimension of the base 10. The first principal surface 10a lies on the upper side of the base 10 as illustrated in FIG. 1, and thus, the first principal surface 10a will sometimes be referred to as an “upper surface.” Similarly, the second principal surface 10b will sometimes be referred to as a “lower surface.” The coil component 1 is arranged such that the second principal surface 10b is opposite to the board 2, and thus, the second principal surface 10b will sometimes be referred to as a “mounting surface.”

In the illustrated embodiment, each of the surfaces 10a to 10f of the base 10 is depicted as a flat surface, but it is to be noted that each of the surfaces 10a to 10f may be a curved surface. In addition, although each of the surfaces 10a to 10f is depicted as being perpendicular to each of the surfaces adjacent thereto, it is to be noted that each of the surfaces 10a to 10f may not be perpendicular to each of the surfaces adjacent thereto. Each of vertices of the base 10 may be rounded, and each of edge lines (i.e., lines representing boundaries between adjacent ones of the surfaces 10a to 10f) of the base 10 may not be a straight line but may be curved in accordance with the shape and arrangement of each of the surfaces 10a to 10f.

The base 10 is made from a mixed resin composition including resin and magnetic powder through, for example, a compression molding method. The magnetic powder is a collection of a multitude of magnetic metal particles. In one embodiment, adjacent ones of the magnetic metal particles in the base 10 are bound to each other through an insulating material. The insulating material is, for example, an insulating binder made of a thermosetting resin that is excellent in insulating property, such as an epoxy resin. In this case, adjacent ones of the magnetic metal particles in the base 10 are bound to each other through the binder. In one embodiment, the binder is the resin included in the mixed resin composition in a cured state.

At least a portion of the coil conductor 25 is wound in a spiral pattern around a coil axis Ax. This coil axis Ax is an imaginary axis that intersects with the upper surface 10a and the lower surface 10b. The coil axis Ax may be, for example, an axis extending along a straight line that passes through a geometric centroid of the upper surface 10a and a geometric centroid of the lower surface 10b when the coil component 1 is viewed in the T-axis direction. The coil axis Ax may extend in a direction perpendicular to both the upper surface 10a and the lower surface 10b. In the present specification, a direction along the coil axis Ax will sometimes be referred to as an “axial direction,” and directions perpendicular to the axial direction and centered on the coil axis Ax will sometimes be referred to as “radial directions.”

In the illustrated embodiment, the coil conductor 25 includes a first turning portion 25a1 having a plurality of turns wound around the coil axis Ax, a first lead portion 25a2 connected to one end of the first turning portion 25a1 and extending up to the lower surface 10b of the base 10 along the T-axis, a second turning portion 25b1 arranged below the first turning portion 25a1 and having a plurality of turns wound around the coil axis Ax, and a second lead portion 25b2 connected to one end of the second turning portion 25b1 and extending up to the lower surface 10b of the base 10 along the T-axis. An end portion of the first turning portion 25a1 opposite to an end portion thereof which is connected to the first lead portion 25a2 is connected to an end portion of the second turning portion 25b1 opposite to an end portion thereof which is connected to the second lead portion 25b2 through a connection portion (not depicted). The coil conductor 25 may have a single-layer structure. In the case where the coil conductor 25 has the single-layer structure, the coil conductor 25 may not include the second turning portion 25b1.

Each of a lower end of the first lead portion 25a2 and a lower end of the second lead portion 25b2 is exposed outside the base 10 through the lower surface 10b. The first lead portion 25a2 is connected to the first external electrode 21 at an end surface thereof exposed through the lower surface 10b, while the second lead portion 25b2 is connected to the second external electrode 22 at an end surface thereof exposed through the lower surface 10b.

In the illustrated embodiment, the first external electrode 21 is provided so as to be in contact with each of the lower surface 10b, the first end surface 10c, the first side surface 10e, and the second side surface 10f of the base 10, but it is to be noted that the shape and arrangement of the first external electrode 21 are not limited to those of the illustrated embodiment. For example, the first external electrode 21 may alternatively be provided on the base 10 so as to be in contact with only the lower surface 10b of the base 10. In another embodiment, the first external electrode 21 may be provided on the base 10 so as to be in contact with the upper surface 10a of the base 10 as well. The shape and arrangement of the second external electrode 22 are not limited to those of the illustrated embodiment. Similarly to the first external electrode 21, the second external electrode 22 may be provided on the base 10 so as to be in contact with only the lower surface 10b of the base 10, and may be provided on the base 10 so as to be in contact with the upper surface 10a of the base 10 as well.

The coil conductor 25 is formed by covering a metal wire made of a metal material excellent in electrical conductivity with an insulating coating surrounding the metal wire. As metal materials used for the coil conductor 25, one or more metals selected from the group consisting of Cu, Al, Ni, and Ag, or an alloy including any of these metals, for example, can be used. The insulating coating provided so as to surround the conducting wire is made of, for example, a polyester imide, a polyamide, or any other insulating material excellent in insulating property.

In the illustrated embodiment, each of the first turning portion 25a1 and the second turning portion 25b1 substantially has only three turns wound around the coil axis Ax. Accordingly, the illustrated coil conductor 25 has a total of only six turns wound around the coil axis Ax. The number of turns of the coil conductor 25 is determined to be, for example, a value between one and six. To achieve a reduced size of the coil component 1, the coil conductor 25 may have only a small number of turns, e.g., six or fewer turns, wound around the coil axis Ax. The number of turns of the coil conductor 25 may be four or less.

Next, a more detailed structure of the base 10 will now be described below, mainly referring to FIGS. 2, 3, and 4. The base 10 includes a first magnetic portion 11 and a second magnetic portion 12. The first magnetic portion 11 is provided outside the coil conductor 25 in the radial directions centered on the coil axis Ax. The first magnetic portion 11 covers an outside the coil conductor 25, and thus, may be referred to as an exterior member. The second magnetic portion 12 is provided inside the first magnetic portion 11 in the radial directions. When a section of the base 10 taken along a plane along the coil axis Ax is observed through a scanning electron microscope (SEM), the first magnetic portion 11 and the second magnetic portion 12 can be distinguished from each other on the basis of differences in contrast (brightness) of an electron microscope image obtained by the observation.

The first magnetic portion 11 includes a first base portion 11a, and a wall portion 11b projecting from the first base portion 11a toward the lower surface 10b along the T-axis direction. The first magnetic portion 11 has a recessed portion 11d having a bottom and recessed from the lower surface 10b toward the upper surface 10a. The recessed portion 11d is defined by the first base portion 11a and the wall portion 11b.

The second magnetic portion 12 is accommodated in the recessed portion 11d of the first magnetic portion 11. The second magnetic portion 12 includes a second base portion 12a, and a projecting portion 12b projecting from a center of the second base portion 12a toward the upper surface 10a along the T-axis direction. The lower surface 10b of the base 10 is defined by the second base portion 12a. The first turning portion 25a1 and the second turning portion 25b1 of the coil conductor 25 are wound around the projecting portion 12b.

The first magnetic portion 11 will be further described below with reference to FIG. 3. The wall portion 11b of the first magnetic portion 11 projects from a periphery of the first base portion 11a toward the lower surface 10b. Accordingly, the first end surface 10c, the second end surface 10d, the first side surface 10e, and the second side surface 10f of the base 10 are defined by an outer peripheral surface of the wall portion 11b. In addition, the upper surface 10a of the base 10 is defined by the first base portion 11a. A bottom surface 11a1 of the recessed portion 11d is defined by a surface of the first base portion 11a opposite to the upper surface 10a, and a side surface 11b1 of the recessed portion 11d is defined by an inner peripheral surface of the wall portion 11b.

The coil conductor 25 is accommodated in the recessed portion 11d of the first magnetic portion 11. An outer peripheral surface of the coil conductor 25 may be in contact with the side surface 11b1 of the first magnetic portion 11. The outer peripheral surface of the coil conductor 25 may alternatively be apart from the side surface 11b1 of the first magnetic portion 11.

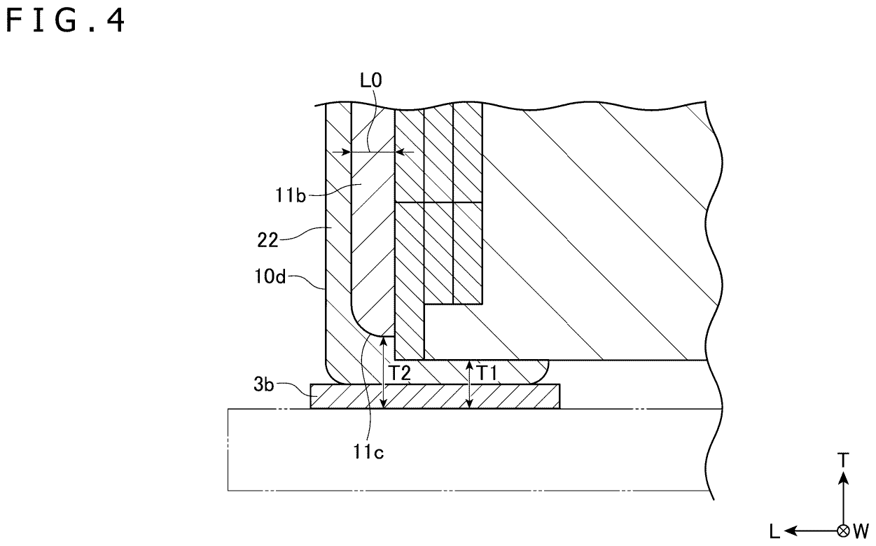

A detailed structure of the coil component 1 will be further described below with reference to FIG. 4. In the case where the coil component 1 is mounted on the mount board 2, a distance T2 between an end surface 11c of the wall portion 11b of the first magnetic portion 11 and a surface of the mount board 2 is greater than a distance T1 between the lower surface 10b (i.e., a lower surface of the second base portion 12a of the second magnetic portion 12) of the base 10 and the surface of the mount board 2. In other words, the end surface 11c of the wall portion 11b is recessed toward the upper surface 10a relative to the lower surface 10b of the base 10. Since the end surface 11c of the wall portion 11b is recessed relative to the lower surface 10b of the base 10, a shoulder may be defined between the end surface 11c of the wall portion 11b and the lower surface 10b of the base 10. In another embodiment, the end surface 11c of the wall portion 11b may be smoothly joined to the lower surface 10b of the base 10.

In one embodiment, a first surface roughness, which represents the surface roughness of the end surface 11c of the wall portion 11b, is greater than a second surface roughness, which represents the surface roughness of the upper surface 10a, the first end surface 10c, the second end surface 10d, the first side surface 10e, or the second side surface 10f of the base 10. As described below, when the base 10 is produced by molding the mixed resin composition, each of the upper surface 10a, the first end surface 10c, the second end surface 10d, the first side surface 10e, and the second side surface 10f is a molded surface in contact with a mold, and is thus formed smoothly. In contrast, the end surface 11c of the wall portion 11b is formed as a result of the resin and magnetic metal particles falling off a molded body through barrel polishing, and is thus a rough surface. Accordingly, the first surface roughness, which represents the surface roughness of the end surface 11c, may be greater than the surface roughness of each of the upper surface 10a, the first end surface 10c, the second end surface 10d, the first side surface 10e, and the second side surface 10f. On the other hand, the lower surface 10b is formed as a result of the molded body being ground in a manufacturing process to expose end surfaces of the coil conductor 25 as described below, and is thus roughened by the grinding. Accordingly, in one embodiment, the first surface roughness, which represents the surface roughness of the end surface 11c of the wall portion 11b, is smaller than a third surface roughness, which represents the surface roughness of the lower surface 10b. The surface roughness is an indicator of smoothness of a surface, and refers to, for example, “arithmetic mean roughness (Ra)” specified in Japanese Industrial Standards (JIS) B 0601:2001. The arithmetic mean roughness can be calculated using a laser microscope having a line roughness analysis function. Specifically, using the laser microscope, an image is taken from a surface that is to be observed, and line segments of a reference length are extracted at ten different positions in the image, and the arithmetic mean roughness can be calculated with respect to the extracted line segments. A microscope on the market can be used as such a laser microscope having the line roughness analysis function.

The wall portion 11b is arranged to have a reduced thickness to achieve a reduced radial dimension of the coil component 1. In the case where the wall portion 11b does not have a uniform radial dimension, it is desirable that a minimum wall portion thickness, which represents a minimum radial dimension of the wall portion 11b, is equal to or smaller than 100 μm. An average wall portion thickness, which represents an average radial dimension of the wall portion 11b, may be equal to or smaller than 100 μm. In one embodiment, the minimum wall portion thickness of the wall portion 11b is greater than an average particle diameter of first magnetic metal particles, which will be described below. When the minimum wall portion thickness of the wall portion 11b is greater than the average particle diameter of the first magnetic metal particles, magnetic metal particles (i.e., first magnetic metal particles) can be filled into the wall portion 11b. It is desirable that the dimension of the wall portion 11b in a radial direction centered on the coil axis Ax is equal to or smaller than 100 μm. To achieve an additional reduction in size of the coil component 1, it is desirable that the dimension of the wall portion 11b in the radial direction is equal to or smaller than 50 μm. It is desirable that the dimension of the wall portion 11b in the radial direction is equal to or greater than 10 μm to ensure sufficient mechanical strength of the wall portion 11b. For example, in the example illustrated in FIG. 4, a dimension L0 of the wall portion 11b in the L-axis direction may be equal to or smaller than 100 μm. The wall portion 11b is provided so as to cover the coil conductor 25 radially outside the coil conductor 25. The wall portion 11b covers the whole of the first turning portion 25a1 and the second turning portion 25b1 of the coil conductor 25 when viewed in the radial direction.

Next, the structures of the first magnetic portion 11 and the second magnetic portion 12, which will be compared with each other, will now be described below. First, voids included in the first magnetic portion 11 and the second magnetic portion 12 will now be described below. As described above, the first magnetic portion 11 and the second magnetic portion 12 are formed by subjecting a mixed resin composition including resin and magnetic powder to compression molding and curing the resin. A molded object formed by compression molding inevitably includes voids. In one embodiment, the first magnetic portion 11 is formed so as to include fewer voids than the second magnetic portion 12. Improvement in mechanical strength of the first magnetic portion 11 can be achieved by arranging the first magnetic portion 11 to include fewer voids than the second magnetic portion 12. Due to the reduced thickness, the wall portion 11b of the first magnetic portion 11 tends to be easily separated from the outer peripheral surface of the coil conductor 25 or the second magnetic portion 12 when the coil component 1 is mounted onto the mount board 2 or at the time of handling of the coil component 1. Improvement in the mechanical strength of the wall portion 11b can be achieved by reducing the proportion of voids in the first magnetic portion 11 including the wall portion 11b. This leads to a reduced likelihood that the wall portion 11b will be damaged when the coil component 1 is mounted onto the mount board 2 or at the time of the handling of the coil component 1.

The proportion of voids included in each of the first magnetic portion 11 and the second magnetic portion 12 can be represented by a porosity indicating the proportion of areas occupied by voids in each of the portions. In one embodiment, in a section of the base 10 taken along a plane along the coil axis Ax, a first porosity, which represents the porosity of the first magnetic portion 11, is smaller than a second porosity, which represents the porosity of the second magnetic portion 12. In the case where the porosity is calculated, the base 10 is first cut along the thickness direction thereof (i.e., the T-axis direction) to expose a section thereof, and this section is imaged with a predetermined magnification (e.g., 10000 times) using an SEM, resulting in a SEM image having a portion of the section of the base 10 as an observation field of view. Next, the SEM image obtained by this imaging is, for example, subjected to image processing, such as a binarization process, to distinguish regions occupied by voids from the other regions, and the area of each of the regions distinguished as voids is calculated. It is to be noted that a multilevel process may alternatively be performed instead of the binarization process. Then, the sum of the areas of the voids in the observation field of view obtained in the above-described manner is calculated, and the total area of the voids in the observation field of view is divided by the area of the observation field of view to calculate the porosity. The porosity expressed in percentage terms is given by the following equation.

Porosity (%)=(total area of voids in observation field of view/gross area of observation field of view)×100

The first magnetic portion 11 may be formed from a first mixed resin composition including a first resin and magnetic powder made up of a plurality of first magnetic metal particles, and the second magnetic portion 12 may be formed from a second mixed resin composition including a second resin and magnetic powder made up of a plurality of second magnetic metal particles. The first magnetic metal particles may be, for example, Fe-based magnetic metal particles made of a Fe-based soft magnetic material. The first magnetic metal particles may contain Si, Al, Cr, and any other additive element in addition to Fe. The second magnetic metal particles may have either the same composition as that of the first magnetic metal particles or a composition different from that of the first magnetic metal particles. The second resin may be either the same type of resin as the first resin or of a type different from that of the first resin. The proportion of the magnetic metal particles in each of the first magnetic portion 11 and the second magnetic portion 12 may be in the range of 70 vol % to 90 vol %. The proportion of regions that are not occupied by the magnetic metal particles in each of the first magnetic portion 11 and the second magnetic portion 12 may be in the range of 10 vol % to 30 vol %. The regions that are not occupied by the magnetic metal particles in each of the first magnetic portion 11 and the second magnetic portion 12 are occupied by a binder or voids.

Next, the filling rate of the magnetic metal particles in each of the first magnetic portion 11 and the second magnetic portion 12 will now be described below. As described above, each of the first magnetic portion 11 and the second magnetic portion 12 is formed from a mixed resin composition including resin and magnetic powder, and thus, each of the first magnetic portion 11 and the second magnetic portion 12 includes magnetic metal particles. Since the wall portion 11b of the first magnetic portion 11 has a reduced thickness, the magnetic metal particles do not easily enter into the wall portion 11b when the coil component 1 is manufactured. Accordingly, coil components known in the art have a problem in that the filling rate of magnetic metal particles in a portion corresponding to the wall portion 11b is low (see, for example, paragraph of Patent Document 1, which has been mentioned above). In contrast, in the coil component 1, a first filling rate, which represents the filling rate of the magnetic metal particles in the first magnetic portion 11, is equal to or substantially equal to a second filling rate, which represents the filling rate of the magnetic metal particles in the second magnetic portion 12, and specifically, the first filling rate is in the range of 0.9 to 1.1 times the second filling rate, both inclusive. In one embodiment, the first filling rate may be equal to or greater than the second filling rate.

The filling rate of the magnetic metal particles in each of the first magnetic portion 11 and the second magnetic portion 12 can be calculated in the following manner. First, the base 10 is cut along the T-axis to expose a section thereof, and this section is imaged with a magnification of 10000 times using an SEM to acquire a SEM image. Next, regions where the magnetic metal particles exist are identified on the basis of differences in brightness in this SEM image, and the combined area of the regions where the magnetic metal particles exist is measured. Then, the ratio of the combined area of the regions where the magnetic metal particles exist to the total area of the observation field of view is calculated, and the calculated ratio expressed in percentage terms is used as the filling rate.

The abovementioned problem of the coil components known in the art, i.e., a lowered filling rate of magnetic metal particles in a reduced-thickness portion like a reduced-thickness portion (e.g., the wall portion 11b) of the first magnetic portion 11, caused by the fact that the magnetic metal particles do not easily enter into the reduced-thickness portion can be overcome by molding the first magnetic portion 11 earlier than the second magnetic portion 12 when the coil component 1 is manufactured. The details of a manufacturing method for improving the first filling rate will be described below. In addition, in one embodiment, a first average particle diameter, which represents the average particle diameter of the first magnetic metal particles contained in the first magnetic portion 11, is arranged to be smaller than a second average particle diameter, which represents the average particle diameter of the second magnetic metal particles contained in the second magnetic portion 12, to make it easier for the magnetic metal particles to be filled into even the wall portion 11b having a reduced thickness, and this leads to improvement in the filling rate of the magnetic metal particles in the wall portion 11b.

Next, the proportion of a binder contained in each of the first magnetic portion 11 and the second magnetic portion 12 will now be described below. As mentioned above, in each of the first magnetic portion 11 and the second magnetic portion 12, the magnetic metal particles are bound to one another through the binder. In the coil component 1, a binder rate (i.e., a first binder rate) representing the proportion of the binder in the first magnetic portion 11 is greater than a binder rate (i.e., a second binder rate) representing the proportion of the binder in the second magnetic portion 12. The binder rate representing the proportion of the binder in each of the first magnetic portion 11 and the second magnetic portion 12 can be calculated in the following manner. First, the base 10 is cut along the T-axis to expose a section thereof, and this section is imaged with a magnification of 10000 times using an SEM to acquire a SEM image. Next, regions where the binder exists are identified on the basis of differences in brightness in this SEM image, and the combined area of the regions where the binder exists is measured. Then, the ratio of the combined area of the regions where the binder exists to the total area of the observation field of view is calculated, and the calculated ratio expressed in percentage terms is used as the binder rate.

In the first magnetic portion 11, the proportion of the regions occupied by the binder is greater than the proportion of the regions occupied by the voids. In other words, the first binder rate is greater than the first porosity. Similarly, in the second magnetic portion 12, the proportion of the regions occupied by the binder is greater than the proportion of the regions occupied by the voids. In other words, the second binder rate is greater than the second porosity.

The average particle diameter of the first magnetic metal particles contained in the first magnetic portion 11 can be determined in the following manner. First, the base 10 is cut along the thickness direction thereof (i.e., the T-axis direction) to expose a section thereof, and a SEM image of a region corresponding to the first magnetic portion 11 in this section is taken with a magnification of approximately 10000 times to approximately 50000 times using an SEM. Next, in the obtained SEM image, the equivalent circle diameters (Heywood diameters) of magnetic metal particles are determined through image analysis, and an average of the equivalent circle diameters of the magnetic metal particles can be used as the average particle diameter of the first magnetic metal particles. As to the average particle diameter of the first magnetic metal particles, a predetermined number (e.g., ten) of magnetic metal particles having the greatest equivalent circle diameters may be selected from a plurality of magnetic metal particles included in the SEM image, and an average of the equivalent circle diameters of the selected magnetic metal particles may be used as the average particle diameter of the first magnetic metal particles. The average particle diameter of the first magnetic metal particles included in the first magnetic portion 11 may be in the range of 1 to 30 μm. The average particle diameter of the second magnetic metal particles contained in the second magnetic portion 12 can be determined in a manner similar to the manner in which the average particle diameter of the first magnetic metal particles can be determined. The average particle diameter of the second magnetic metal particles included in the second magnetic portion 12 may be in the range of 0.5 to 5 μm.

As described above, in the coil component 1, improvement in magnetic characteristics of the base 10 can be achieved by improving the filling rate of the magnetic metal particles in the wall portion 11b. The coil components known in the art have a problem in that the filling rate of magnetic metal particles in a reduced-thickness portion like the wall portion 11b is lowered, leading to deterioration in magnetic characteristics, while in the coil component 1, the filling rate (i.e., the first filling rate) of the magnetic metal particles in the first magnetic portion 11 including the wall portion 11b having a reduced thickness is arranged to be equal to or substantially equal to the filling rate (i.e., the second filling rate) of the magnetic metal particles in the second magnetic portion 12 to minimize deterioration in magnetic characteristics caused by the wall portion 11b having a reduced thickness.

In addition, the coil component 1 is able to achieve improved mechanical strength of the wall portion 11b because the improvement in the filling rate of the magnetic metal particles in the wall portion 11b facilitates firm binding between adjacent ones of the magnetic metal particles in the wall portion 11b.

As described above, in the coil component 1, the first porosity, which represents the porosity of the first magnetic portion 11, is smaller than the second porosity, which represents the porosity of the second magnetic portion 12, and the mechanical strength of the first magnetic portion 11 is thereby improved. This contributes to preventing damage to the wall portion 11b having a reduced thickness in the first magnetic portion 11.

In addition, in the coil component 1, the end surface 11c of the wall portion 11b is recessed relative to the lower surface 10b of the base 10, and this contributes to preventing an end portion of the wall portion 11b from colliding with the mount board 2 or a gripping member of a mounter when the coil component 1 is mounted onto the mount board 2 or at the time of the handling of the coil component 1. This in turn contributes to more effectively preventing the wall portion 11b from being damaged at the time of the mounting or handling of the coil component 1.

### 2. Second Embodiment

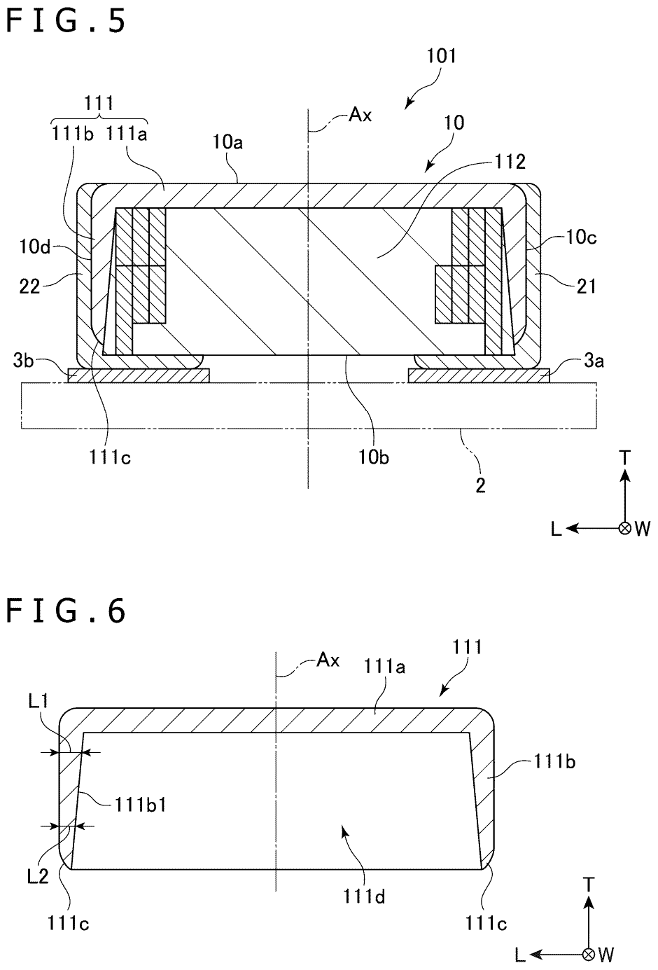

Next, a coil component 101 according to a second embodiment of the present disclosure will be described below with reference to FIGS. 5 and 6. FIG. 5 is a vertical sectional view of the coil component 101 according to the second embodiment, and FIG. 6 is a schematic sectional view of a first magnetic portion 111 included in the coil component 101. The coil component 101 is different from the coil component 1 in that the coil component 101 includes the first magnetic portion 111 in place of the first magnetic portion 11, and includes a second magnetic portion 112 in place of the second magnetic portion 12.

As illustrated in FIG. 6, the first magnetic portion 111 includes a first base portion 111a, and a wall portion 111b projecting from the first base portion 111a toward a lower surface 10b along the T-axis direction. The first magnetic portion 111 has a recessed portion 111d. The second magnetic portion 112 is accommodated in the recessed portion 111d of the first magnetic portion 111.

The wall portion 111b includes an outer peripheral surface extending along the T-axis direction, and an inner peripheral surface 111b1 angled with respect to the outer peripheral surface. In one embodiment, in a section of a base 10 taken along a plane along a coil axis Ax, the angle of the inner peripheral surface 111b1 with respect to the outer peripheral surface of the wall portion 111b is in the range of 3° to 5° both inclusive. The inner peripheral surface 111b1 of the wall portion 111b is angled with respect to the outer peripheral surface of the wall portion 111b such that the wall portion 111b has a greater thickness in the vicinity of the first base portion 111a than in the vicinity of an end surface 111c of the wall portion 111b. More specifically, due to the angle of the inner peripheral surface 111b1 with respect to the outer peripheral surface of the wall portion 111b, a first wall portion thickness L1, which represents the radial dimension of the wall portion 111b at a first position in the axial direction along the coil axis Ax, is greater than a second wall portion thickness L2, which represents the radial dimension of the wall portion 111b at a second position that is more distant from the first base portion 111a (i.e., closer to the lower surface 10b) in the axial direction than is the first position.

The coil component 101 exhibits the following additional advantageous effect in addition to the advantageous effects exhibited by the coil component 1. That is, the coil component 101 is able to achieve improved mechanical strength of a portion (i.e., a portion in the vicinity of the first base portion 111a) of the wall portion 111b near a base thereof, and this contributes to preventing a stress acting on the wall portion 111b at the time of mounting or handling of the coil component 101 from damaging the wall portion 111b because the wall portion 111b is firmly supported in the vicinity of the base thereof.

### 3. Third Embodiment

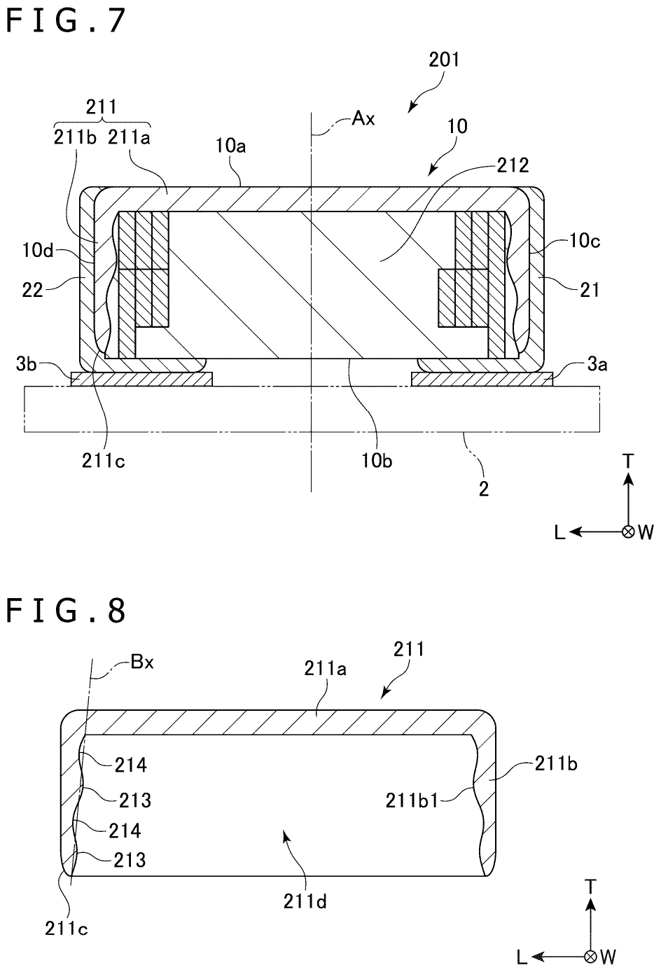

Next, a coil component 201 according to a third embodiment of the present disclosure will be described below with reference to FIGS. 7 and 8. FIG. 7 is a vertical sectional view of the coil component 201 according to the third embodiment, and FIG. 8 is a schematic sectional view of a first magnetic portion 211 included in the coil component 201. The coil component 201 is different from the coil component 101 in that the coil component 201 includes the first magnetic portion 211 in place of the first magnetic portion 111, and includes a second magnetic portion 212 in place of the second magnetic portion 112.

As illustrated in FIG. 8, the first magnetic portion 211 includes a first base portion 211a, and a wall portion 211b projecting from the first base portion 211a toward a lower surface 10b along the T-axis direction. The first magnetic portion 211 has a recessed portion 211d. The second magnetic portion 212 is accommodated in the recessed portion 211d of the first magnetic portion 211.

An inner peripheral surface 211b1 of the wall portion 211b is not flat, but has irregularities. The irregularities are defined by at least one small projection 213 and at least one small recess 214 formed in the inner peripheral surface 211b1 of the wall portion 211b. The inner peripheral surface 211b1 of the wall portion 211b may have a plurality of small projections 213 and a plurality of small recesses 214 as the irregularities. In the illustrated embodiment, the inner peripheral surface 211b1 has two small projections 213 and two small recesses 214 as the irregularities. Assuming an imaginary line Bx that joins a position at which a lower end of the wall portion 211b is in contact with the second magnetic portion 212 and a position at which the inner peripheral surface 211b1 of the wall portion 211b intersects with the first base portion 211a in a section of the base 10 taken along a plane along a coil axis Ax, portions of the inner peripheral surface 211b1 of the wall portion 211b which lie radially inside the imaginary line Bx correspond to the small projections 213, and portions of the inner peripheral surface 211b1 of the wall portion 211b which lie radially outside the imaginary line Bx correspond to the small recesses 214. The height of each small projection 213 relative to the imaginary line Bx is greater than the average particle diameter of first magnetic metal particles contained in the first magnetic portion 211. The height of the small projection 213 refers to the length of a perpendicular from a portion of the inner peripheral surface 211b1 of the wall portion 211b which is most radially inward from the imaginary line Bx to the imaginary line Bx. The depth of each small recess 214 relative to the imaginary line Bx is greater than the average particle diameter of the first magnetic metal particles contained in the first magnetic portion 211. The depth of the small recess 214 refers to the length of a perpendicular from a portion of the inner peripheral surface 211b1 of the wall portion 211b which is most radially outward from the imaginary line Bx to the imaginary line Bx. If an area in the vicinity of a boundary between the first magnetic portion 211 and the second magnetic portion 212 in the section of the base 10 taken along the plane along the coil axis Ax is determined to be an observation field of view, and this observation field of view is observed through an SEM, the first magnetic portion 211 and the second magnetic portion 212 can be distinguished from each other on the basis of differences in contrast (brightness) of an electron microscope image obtained by the observation. At this time, irregularities larger than the average particle diameter of the first magnetic metal particles can be recognized at the boundary between the first magnetic portion 211 and the second magnetic portion 212.

The small projections 213 and the small recesses 214 may be arranged to extend either over the whole of the inner peripheral surface 211b1 of the wall portion 211b or over only a partial region of the inner peripheral surface 211b1. For example, the small projections 213 and the small recesses 214 may be arranged in a region of the inner peripheral surface 211b1 of the wall portion 211b which lies on the side of a midpoint in the T-axis direction closer to the lower surface 10b (i.e., closer to an end surface 211c), with none of the small projections 213 and the small recesses 214 being arranged in a region of the inner peripheral surface 211b1 which lies on the side of the midpoint closer to an upper surface 10a.

The coil component 201 exhibits the following additional advantageous effect in addition to the advantageous effects exhibited by the coil component 101. That is, the coil component 201 achieves an increase in strength with which the first magnetic portion 211 and the second magnetic portion 212 are joined to each other due to the irregularities provided in the inner peripheral surface 211b1 of the wall portion 211b, and this contributes to preventing the first magnetic portion 211 from being separated from the second magnetic portion 212 even when a force acting in the T-axis direction is applied to the second magnetic portion 212 at the time of mounting, handling, or use of the coil component 201.

### 4. Manufacturing Method

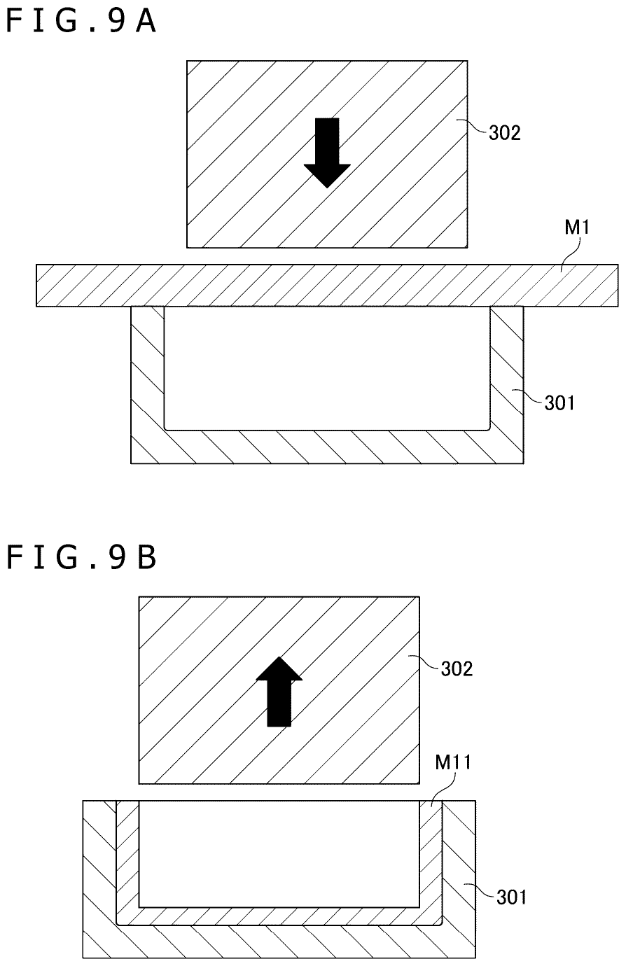

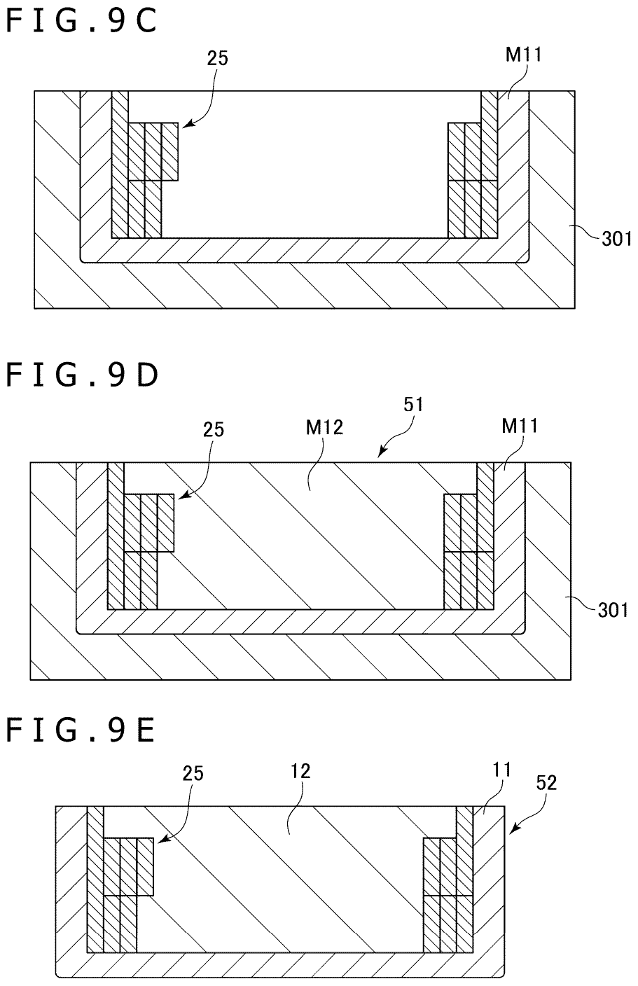

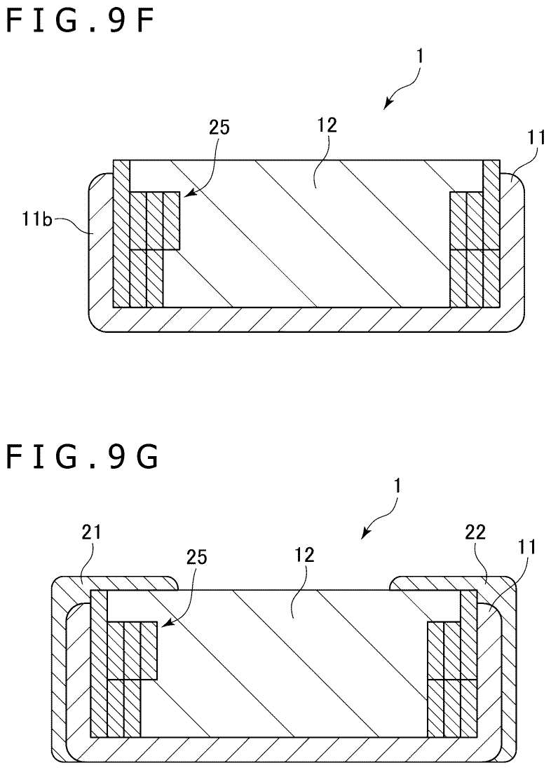

Next, an example method for manufacturing the coil component 1 will be described below with reference to FIGS. 9A, 9B, 9C, 9D, 9E, 9F, and 9G. First, as illustrated in FIG. 9A, the first mixed resin composition including the first resin and the magnetic powder made up of the plurality of first magnetic metal particles is molded into the shape of a plate, and a semi-cured body M1 obtained by partially curing the plate-shaped mixed resin composition is set so as to cover a cavity of a mold 301. The semi-cured body M1 is a molded body including the plurality of first magnetic metal particles and the first resin in a semi-cured state. The first resin is a thermosetting resin excellent in insulating property, such as an epoxy resin, benzocyclobutene (BCB), a phenol resin, an unsaturated polyester resin, a vinylester resin, a polyimide resin (PI), a polyphenylene ether oxide resin (PPO), a bismaleimide-triazine cyanate ester resin, a fumarate resin, a polybutadiene resin, or a polyvinyl benzyl ether resin.

Next, a punch 302 is lowered to force the semi-cured body M1 into the cavity of the mold 301, and pressure is applied to the semi-cured body M1 through the mold 301 and the punch 302. Thereafter, the punch 302 is lifted such that a first molded body M11 having a shape corresponding to that of the cavity of the mold 301 is obtained as illustrated in FIG. 9B. The first molded body M11 includes a bottom portion M11a and a side wall M11b. The first molded body M11 has a recessed portion defined by the bottom portion M11a and the side wall M11b. The side wall M11b can be arranged to have a dimension in the range of 10 to 100 μm by adjusting the dimensions of the mold 301 and the punch 302.

Note that the first molded body M11 may be made without using the semi-cured body M1. For example, the first molded body M11 may be made from the mixed resin composition by a transfer molding method or any other known molding method.

Next, the coil conductor 25 prepared in advance is set in the recessed portion of the first molded body M11 as illustrated in FIG. 9C.

Next, as illustrated in FIG. 9D, the second mixed resin composition including the second resin and the magnetic powder made up of the plurality of second magnetic metal particles is filled into the recessed portion of the first molded body M11, and the filled second mixed resin composition is subjected to application of pressure through a punch, which is not depicted, together with the first molded body M11 and the coil conductor 25. Alternatively, the second mixed resin composition may be molded into the shape of a plate, and a semi-cured body obtained by partially curing the plate-shaped mixed resin composition may be set over the recessed portion of the first molded body M11, and then, the semi-cured body may be forced into the recessed portion of the first molded body M11 through a punch. It is desirable that the average particle diameter of the second magnetic metal particles included in the second mixed resin composition is greater than the average particle diameter of the first magnetic metal particles included in the first mixed resin composition. The second resin is a thermosetting resin excellent in insulating property. The second resin may be either the same type of resin as the first resin or of a type different from that of the first resin. As a result of the application of pressure to the second mixed resin composition in the recessed portion of the first molded body M11, the second resin contained in the second mixed resin composition passes through a gap of the coil conductor 25 to reach the first molded body M11, and enters into the first molded body M11. As a result, voids in the first molded body M11 are filled with the second resin, resulting in a reduced porosity of the first molded body M11. Instead of the application of pressure to the second mixed resin composition in the recessed portion of the first molded body M11, the second mixed resin composition may be heated at a temperature equal to or lower than the curing temperature of the second resin to cause the second resin in the second mixed resin composition to be melted to enter into the first molded body M11 through the gap of the coil conductor 25. Note that the second mixed resin composition may be subjected to both the application of pressure and heating.

The first molded body M11 and the second mixed resin composition filled in the recessed portion of the first molded body M11 are heated at a molding temperature equal to or higher than the curing temperatures of the first resin and the second resin, whereby the first magnetic portion 11 is formed from the first molded body M11, and the second magnetic portion 12 is formed from the second mixed resin composition filled in the recessed portion of the first molded body M11. In the case where an epoxy resin is used as each of the first resin and the second resin, the molding temperature may be approximately 150° C. In one embodiment, during the compression molding of the second mixed resin composition, a molding temperature equal to or higher than the curing temperatures of the first resin and the second resin may be applied to perform the compression molding of the second mixed resin composition and the curing of the first resin and the second resin in parallel. In another embodiment, pressure may be applied to the second mixed resin composition filled in the recessed portion of the first molded body M11 under a temperature equal to or lower than the curing temperatures of the first resin and the second resin to form a second molded body M12 accommodated in the recessed portion of the first molded body M11, and thereafter, the first molded body M11 and the second molded body M12 may be baked at a temperature equal to or higher than the curing temperatures of the first resin and the second resin to form the first magnetic portion 11 from the first molded body M11 and form the second magnetic portion 12 from the second molded body M12.

Next, an intermediate molded body 51 including the first magnetic portion 11 and the second magnetic portion 12 formed in the above-described manner is taken out of the mold 301, and one surface of the intermediate molded body 51 is ground through a cutting blade or a laser to expose end surfaces of the coil conductor 25 from the second magnetic portion 12. As a result of this grinding, an intermediate molded body 52 illustrated in FIG. 9E is obtained. In the intermediate molded body 52, one end surface and another end surface of the coil conductor 25 are exposed from the second magnetic portion 12. The intermediate molded body 52 is substantially in the shape of a rectangular parallelepiped.

Next, the intermediate molded body 52 is subjected to barrel polishing, whereby corners and edge lines of the intermediate molded body 52 are rounded. In this barrel polishing, the magnetic metal particles and resin in the vicinity of a distal end of the wall portion 11b of the first magnetic portion 11 tend to easily fall off the intermediate molded body 52, and thus, after the barrel polishing, the distal end of the wall portion 11b is recessed relative to a surface (i.e., the surface where the end surfaces of the coil conductor 25 are exposed) of the second magnetic portion 12 as illustrated in FIG. 9F.

Next, as illustrated in FIG. 9G, an electrically conductive paste is applied so as to cover the one end surface of the coil conductor 25 and a first region of the end surface 11c of the wall portion 11b to form the first external electrode 21, while an electrically conductive paste is applied so as to cover the other end surface of the coil conductor 25 and a second region of the end surface 11c of the wall portion 11b to form the second external electrode 22. The first external electrode 21 and the second external electrode 22 are formed so as to cover the end surfaces of the coil conductor 25 which are exposed from the second magnetic portion 12 and the end surface 11c at the distal end of the wall portion 11b. The electrically conductive paste includes an electrically conductive material excellent in electrical conductivity, such as Ag, Pd, Cu, Al, Ni, or an alloy thereof. A plating layer may be formed on a surface of each of the first external electrode 21 and the second external electrode 22. This plating layer may be made up of two or more layers. The two or more plating layers may include an Ni plating layer and an Sn plating layer provided outside the Ni plating layer.

The coil component 1 is manufactured in the above-described manner. According to the above-described manufacturing method, the first molded body M11, which is a precursor of the first magnetic portion 11, is molded prior to injection of the second mixed resin composition, which is a material of the second magnetic portion 12, and thus, the reduced thickness of the wall portion 11b does not hinder the filling of the first magnetic metal particles into the wall portion 11b. This allows the wall portion 11b to contain the first magnetic metal particles with a high filling rate, which contributes to preventing deterioration in magnetic characteristics caused by an insufficient filling rate of the first magnetic metal particles in the wall portion 11b. In addition, the high filling rate of the first magnetic metal particles in the wall portion 11b leads to improved mechanical strength of the wall portion 11b. Further, the above-described manufacturing method allows the wall portion 11b to contain the resin and the first magnetic metal particles with a high filling rate, and this leads to improved mechanical strength of the wall portion 11b.

In addition, according to the above-described manufacturing method, the second mixed resin composition in the recessed portion of the first molded body M11 is subjected to one of or both the application of pressure and heating, whereby the second resin in the second mixed resin composition enters into voids inside the first molded body M11, and this leads to a reduced porosity of the first molded body M11. This in turn leads to a reduced porosity of the first magnetic portion 11, which is formed as a result of curing the first molded body M11. Thus, the above-described manufacturing method is able to achieve improved mechanical strength of the first magnetic portion 11, and, in particular, is able to achieve improved mechanical strength of the wall portion 11b having a reduced thickness. An additional improvement in the mechanical strength of the wall portion 11b can be achieved by increasing the filling rate of the first magnetic metal particles in the wall portion 11b while reducing the porosity of the wall portion 11b.

Further, according to the above-described manufacturing method, the intermediate molded body 52 including the first magnetic portion 11 and the second magnetic portion 12 is subjected to barrel polishing, whereby the end surface 11c of the wall portion 11b having a reduced thickness can be recessed relative to the lower surface 10b of the base 10, and this contributes to preventing an end portion of the wall portion 11b from colliding with the mount board 2 or a gripping member of a mounter when the coil component 1 is mounted onto the mount board 2 or at the time of the handling of the coil component 1. This in turn contributes to preventing the wall portion 11b from being damaged at the time of the mounting or handling of the coil component 1. Furthermore, when the wall portion 11b is arranged to have a thickness equal to or smaller than 100 μm at the end surface 11c, a portion of the intermediate molded body 52 which corresponds to a precursor of the wall portion 11b tends to easily fall off during the barrel polishing of the intermediate molded body 52, allowing the end surface 11c of the wall portion 11b to be significantly recessed relative to the lower surface 10b of the base 10, and allowing the wall portion 11b as a whole to be recessed.

Furthermore, the above-described manufacturing method enables more of the magnetic metal particles to fall off at the distal end of the wall portion 11b of the first magnetic portion 11 through the barrel polishing, making it possible to make the surface roughness of the end surface 11c of the wall portion 11b greater than the surface roughness of the upper surface 10a, the first end surface 10c, the second end surface 10d, the first side surface 10e, or the second side surface 10f of the base 10. Since each of the first external electrode 21 and the second external electrode 22 is formed so as to cover a portion of the end surface 11c of the wall portion 11b, each of the first external electrode 21 and the second external electrode 22 can be securely joined to the base 10.

Furthermore, according to the above-described manufacturing method, each of the upper surface 10a, the first end surface 10c, the second end surface 10d, the first side surface 10e, and the second side surface 10f among the outer surfaces that define the base 10 can be formed as a smooth molded surface by the mold. Accordingly, a defect, an insulation degradation, or other problems that can be caused by working such as grinding does not occur in the upper surface 10a, the first end surface 10c, the second end surface 10d, the first side surface 10e, or the second side surface 10f. Thus, according to the above-described manufacturing method, five out of the six surfaces (i.e., the surfaces other than the lower surface 10b) of the base 10 can be formed smoothly.

One or more steps included in the above-described manufacturing method can be omitted as appropriate. In the method for manufacturing the coil component 1, a step or steps that are not explicitly described in the present specification may be performed as necessary. Some of the steps included in the above-described method for manufacturing the coil component 1 can be switched in order and performed when necessary without departing from the scope and spirit of the present disclosure. Some of the steps included in the above-described method for manufacturing the coil component 1 may be performed simultaneously or in parallel, if possible.

In the above-described manufacturing method, in place of the mold 301, a frame having a portion made of resin and having a recessed portion or through hole having the same shape as that of the cavity of the mold 301 may be used to form the intermediate molded body 51. When the material is molded using the frame having a portion made of resin, it is unlikely that a side surface of the molded body will be flawed when the molded body is removed from the frame having a portion made of resin. Reducing flaws in the side surface of the molded body presents the coil component made from the molded body with advantages of increased insulation of an external surface thereof and of increased mechanical strength thereof due to a reduced structural defect in the external surface. In addition, because the processes of subsequent steps can be performed while the molded body is held in the frame, increases in efficiency and precision of a manufacturing process can be achieved. When coil components having a small size (for example, with a side length of 2 mm or less) are manufactured, handling of extremely small intermediate bodies (molded bodies) that occur during a manufacturing process involves difficulty, but because the intermediate bodies can be collectively handled when the coil components are manufactured using a frame having a portion made of resin, increases in efficiency and precision of the manufacturing process can be accomplished by using the frame having a portion made of resin to manufacture the small-sized coil components.

### 5. Notes

Note that the dimensions, materials, and arrangements of the constituent elements described in the foregoing descriptions of various embodiments of the present disclosure are not limited to those described explicitly in the descriptions of the embodiments and that the constituent elements can be modified so as to have any desired dimensions, materials, and arrangements that can fall within the scope of the present disclosure.

Also note that a constituent element that has not been explicitly described in the present specification may be added to any of the embodiments described above and that one or more of the constituent elements described in the descriptions of the embodiments may be omitted.

Note that the terms “first,” “second,” “third,” and so on as used in the present specification are added simply to identify constituent elements, and are not necessarily meant to limit the number, order, or contents of the constituent elements. Also note that numbers for identifying constituent elements are used for each context and that a number used to indicate a certain constituent element in one context does not necessarily indicate the same constituent element in another context. Also note that a constituent element identified by a certain number may additionally serve a function of a constituent element identified by another number.

### 6. Additions

The embodiments disclosed herein include the following items.

### [Item 1]

A coil component including:
a base including a plurality of magnetic metal particles; and
a coil conductor wound around a coil axis inside the base, in which
the base includes a first magnetic portion provided outside the coil conductor in radial directions centered on the coil axis, and a second magnetic portion provided inside the first magnetic portion in the radial directions, and
a first filling rate is in a range of 0.9 to 1.1 times a second filling rate, both inclusive, the first filling rate representing a filling rate of the magnetic metal particles in the first magnetic portion, and the second filling rate representing a filling rate of the magnetic metal particles in the second magnetic portion.

### [Item 2]

The coil component according to [Item 1], in which the first filling rate is equal to or greater than the second filling rate.

### [Item 3]

The coil component according to [Item 1] or [Item 2], in which
the plurality of magnetic metal particles include first magnetic metal particles contained in the first magnetic portion, and second magnetic metal particles contained in the second magnetic portion, and
a first average particle diameter is smaller than a second average particle diameter, the first average particle diameter representing an average particle diameter of the first magnetic metal particles, and the second average particle diameter representing an average particle diameter of the second magnetic metal particles.

### [Item 4]

The coil component according to any one of [Item 1] to [Item 3], in which
the base includes a first surface that crosses the coil axis, and a second surface opposite to the first surface,
the first magnetic portion has a recessed portion recessed from the first surface toward the second surface, and
the second magnetic portion is accommodated in the recessed portion.

### [Item 5]

The coil component according to any one of [Item 1] to [Item 4], in which the first magnetic portion includes a first base portion defining a bottom surface of the recessed portion, and a wall portion projecting from the first base portion toward the first surface along the coil axis.

### [Item 6]

The coil component according to any one of [Item 1] to [Item 5], in which a minimum wall portion thickness is equal to or smaller than 100 μm, the minimum wall portion thickness representing a minimum dimension of the wall portion in a radial direction centered on the coil axis.

### [Item 7]

The coil component according to any one of [Item 1] to [Item 6], in which
the second magnetic portion includes a second base portion defining at least a portion of the first surface of the base, and a projecting portion projecting from the second base portion toward the second surface, and
the coil conductor is wound around the projecting portion.

### [Item 8]

The coil component according to any one of [Item 1] to [Item 7], in which
the base includes a third surface connecting the first surface and the second surface, and a fourth surface opposite to the third surface,
each of the third surface and the fourth surface is defined by an outer peripheral surface of the wall portion,
a side surface of the recessed portion is defined by an inner peripheral surface of the wall portion, and
the inner peripheral surface of the wall portion is angled with respect to the outer peripheral surface of the wall portion such that a first wall portion thickness is greater than a second wall portion thickness, the first wall portion thickness representing a dimension of the wall portion in a radial direction centered on the coil axis at a first position in an axial direction along the coil axis, and the second wall portion thickness representing a dimension of the wall portion in the radial direction at a second position that is closer to the first surface in the axial direction than is the first position.

### [Item 9]

The coil component according to any one of [Item 1] to [Item 8], in which a side surface of the recessed portion is defined by an inner peripheral surface of the wall portion, and the inner peripheral surface has irregularities formed therein.

### [Item 10]

The coil component according to any one of [Item 1] to [Item 9], in which
the coil conductor includes a turning portion extending in a circumferential direction about the coil axis, a first lead portion extending from one end of the turning portion up to the first surface, and a second lead portion extending from another end of the turning portion up to the first surface, and
the wall portion covers the turning portion of the coil conductor from radially outside.

### [Item 11]

The coil component according to any one of [Item 1] to [Item 10], in which
the coil conductor includes a turning portion extending in a circumferential direction about the coil axis, a first lead portion extending from one end of the turning portion up to the first surface, and a second lead portion extending from another end of the turning portion up to the first surface, and
the turning portion has less than six turns wound around the coil axis.

### [Item 12]

The coil component according to any one of [Item 1] to [Item 11], in which the turning portion has less than four turns wound around the coil axis.

### [Item 13]

The coil component according to any one of [Item 1] to [Item 12], further including:
a first external electrode provided at least on the first surface of the base and connected to the first lead portion; and
a second external electrode provided at least on the first surface of the base and connected to the second lead portion.

### [Item 14]

The coil component according to [Item 1], in which the first filling rate is in a range of 0.9 to 0.99 times the second filling rate, both inclusive.

### [Item 15]

The coil component according to [Item 1], in which the first filling rate is in a range of 1.01 to 1.1 times the second filling rate, both inclusive.

What is claimed is:

1. A coil component comprising:
a base including a plurality of magnetic metal particles; and
a coil conductor wound around a coil axis inside the base, wherein
the base includes a first magnetic portion provided outside the coil conductor in radial directions centered on the coil axis, and a second magnetic portion provided inside the first magnetic portion in the radial directions, and
a first filling rate is in a range of 0.9 to 1.1 times a second filling rate, both inclusive, the first filling rate representing a filling rate of the magnetic metal particles in the first magnetic portion, and the second filling rate representing a filling rate of the magnetic metal particles in the second magnetic portion.

2. The coil component according to claim 1, wherein the first filling rate is equal to or greater than the second filling rate.

3. The coil component according to claim 1, wherein
the plurality of magnetic metal particles include first magnetic metal particles contained in the first magnetic portion, and second magnetic metal particles contained in the second magnetic portion, and
a first average particle diameter is smaller than a second average particle diameter, the first average particle diameter representing an average particle diameter of the first magnetic metal particles, and the second average particle diameter representing an average particle diameter of the second magnetic metal particles.

4. The coil component according to claim 1, wherein
the base includes a first surface that crosses the coil axis, and a second surface opposite to the first surface,
the first magnetic portion has a recessed portion recessed from the first surface toward the second surface, and
the second magnetic portion is accommodated in the recessed portion.

5. The coil component according to claim 4, wherein the first magnetic portion includes a first base portion defining a bottom surface of the recessed portion, and a wall portion projecting from the first base portion toward the first surface along the coil axis.

6. The coil component according to claim 5, wherein a minimum wall portion thickness is equal to or smaller than 100 μm, the minimum wall portion thickness representing a minimum dimension of the wall portion in a radial direction centered on the coil axis.

7. The coil component according to claim 4, wherein
the second magnetic portion includes a second base portion defining at least a portion of the first surface of the base, and a projecting portion projecting from the second base portion toward the second surface, and
the coil conductor is wound around the projecting portion.

8. The coil component according to claim 5, wherein
the base includes a third surface connecting the first surface and the second surface, and a fourth surface opposite to the third surface,
each of the third surface and the fourth surface is defined by an outer peripheral surface of the wall portion,
a side surface of the recessed portion is defined by an inner peripheral surface of the wall portion, and
the inner peripheral surface of the wall portion is angled with respect to the outer peripheral surface of the wall portion such that a first wall portion thickness is greater than a second wall portion thickness, the first wall portion thickness representing a dimension of the wall portion in a radial direction centered on the coil axis at a first position in an axial direction along the coil axis, and the second wall portion thickness representing a dimension of the wall portion in the radial direction at a second position that is closer to the first surface in the axial direction than is the first position.

9. The coil component according to claim 5, wherein
a side surface of the recessed portion is defined by an inner peripheral surface of the wall portion, and
the inner peripheral surface has irregularities formed therein.

10. The coil component according to claim 5, wherein
the coil conductor includes a turning portion extending in a circumferential direction about the coil axis, a first lead portion extending from one end of the turning portion up to the first surface, and a second lead portion extending from another end of the turning portion up to the first surface, and
the wall portion covers the turning portion of the coil conductor from radially outside.

11. The coil component according to claim 4, wherein
the coil conductor includes a turning portion extending in a circumferential direction about the coil axis, a first lead portion extending from one end of the turning portion up to the first surface, and a second lead portion extending from another end of the turning portion up to the first surface, and
the turning portion has less than six turns wound around the coil axis.

12. The coil component according to claim 11, wherein the turning portion has less than four turns wound around the coil axis.

13. The coil component according to claim 12, further comprising:
a first external electrode provided at least on the first surface of the base and connected to the first lead portion; and
a second external electrode provided at least on the first surface of the base and connected to the second lead portion.

14. The coil component according to claim 1, wherein the first filling rate is in a range of 0.9 to 0.99 times the second filling rate, both inclusive.

15. The coil component according to claim 1, wherein the first filling rate is in a range of 1.01 to 1.1 times the second filling rate, both inclusive.
